(19) United States
(12) Patent Application Publication
(10) Pub. No.: US 2014/0285344 A1
(43) Pub. Date: Sep. 25, 2014

(54) CONTAMINATION MONITORING DEVICE

(71) Applicant: Kenneth Alaric Best, Lancashire (GB)

(72) Inventor: Kenneth Alaric Best, Lancashire (GB)

(73) Assignee: VERAZ LIMITED, Lancashire (GB)

(21) Appl. No.: 13/980,956

(22) PCT Filed: Jan. 20, 2012
(86) PCT No.: PCT/GB2012/050130

§ 371 Date: Dec. 2, 2013

(30) Foreign Application Priority Data
Jan. 22, 2011 (GB) 1101164.0

(51) Int. Cl. G08B 21/24

(52) U.S. Cl. CPC G08B 21/245
USPC 340/573.1

(57) ABSTRACT

The present invention relates to a contamination monitoring device for monitoring contamination potential associated with a user. The device comprises attachment means for holding the device in proximity of the user, a sensor being operable to detect the presence of a washing action and output a signal indicative thereof and an indicator being operable to receive signals output by the sensor and output an indication in response thereto.

The present invention relates to a device for monitoring contamination potential associated with a user.

In some environments, hygiene or the avoidance of cross-contamination is of significant importance. As such, considerable precautions may be taken by persons operating in, or visiting, these environments. These precautions may include both specially adapted equipment and/or special operational procedures. Unfortunately, the existence of such equipment or procedures does not verify that they will be utilised correctly at all times. In the particular case of operational procedures it can be very difficult to adequately monitor an individual's actions at all times.

An example of such difficulties is illustrated by considering a hospital. Within a hospital, infectious diseases may be spread from patient to patient by contact with members of staff, visitors and the like. Accordingly, most hospitals have strict hygiene protocols, in particular a strict protocol requiring individuals to wash their hands before entry into wards or other areas where patients may be present, and again after patient (or other potentially risky) contact. Typically, a sanitising composition containing alcohol is used as a disinfectant during hand washing. It has however also been well documented that poor compliance with such protocols are not uncommon. Additionally, without equally unreliable, direct vigilance from other members of staff, it is very difficult to monitor whether a member of staff, visitor or other person in contact with, or in the vicinity of, a patient has complied with the protocols, and thus be aware of the contamination potential associated with that individual.

It is therefore an object of the present invention to provide a device that at least partially alleviates or overcomes the above problems.

According to a first aspect of the present invention, there is provided a contamination monitoring device for monitoring contamination potential associated with a user, the device comprising: attachment means for holding the device in proximity of the user; a sensor being operable to detect the presence of a washing action and output a signal indicative thereof; and an indicator being operable to receive signals output by the sensor and output an indication in response thereto.

The sensor may comprise any suitable sensor for detecting the presence of a washing action and outputting a signal indicative thereof. The sensor may comprise, but is not limited to, any of the following either alone or in combination: a vapour sensor, a temperature sensor, an image/video sensor, for example, a camera; and an audio sensor, for example, a microphone. It will be appreciated by a person skilled in the art that the sensor could equally comprise any other suitable means of detecting the presence of a washing action and outputting a signal indicative thereof without departing from the scope of the present invention.

The sensor may be operable to output a signal indicative of the quality of the washing action. The signal may be variable in response to, for example, the duration of the washing action detected by an image/video or audio sensor; the temperature of water utilised in the washing action detected by a temperature sensor; or the volume, concentration, rate of change of concentration and/or duration of a vapour component detected by a vapour sensor.

According to a second aspect of the present invention, there is provided a contamination monitoring device for monitoring contamination potential associated with a user, the device comprising: attachment means for holding the device in proximity of the user; a sensor being operable to detect the presence of a vapour component and output a signal indicative thereof; and an indicator being operable to receive signals output by the sensor and output an indication in response thereto.

The contamination monitoring device of the present invention can be used to indicate whether a user poses a potential for contamination. The output from the indicator can enable constant monitoring of the level of contamination potential associated with the user. This is particularly advantageous in an environment that requires a high degree of cleanliness to be maintained, such as for example, a hospital or other health care environment. The present invention allows this to be achieved by detecting the characteristic vapour from a sanitising composition.

The user may be a member of staff, visitor or other person present in an environment where there is a potential for contamination and/or wherein a high degree of cleanliness is required.

The sensor may be operable to output any suitable form of signal. For example, the signal may be an electrical or chemical signal.

In preferred embodiments, the signal output from the sensor may be an electrical signal. In such embodiments, the signal can only be received by the provision of an electrical pathway between the sensor and the indicator. This may be achieved if there is an electrical contact between the sensor and the indicator. The electrical contact may be direct or indirect. The electrical signal may be a low power signal. This can reduce or avoid the danger of electrocution or ignition.

The sensor and the indicator may be in communication by means of any suitable wired or wireless link.

The signal may be variable in response to the volume, concentration and/or duration of the vapour component detected by the sensor. Alternatively, the signal may be variable in response to a rate of change of concentration of the vapour component detected by the sensor.

The sensor may output a signal in response to any detection of the vapour component. In some circumstances, it may be desirable for the sensor to output a signal only after a certain threshold level of the vapour component has been detected. The threshold level may differ depending on the requirements in the particular environment in which the device is in use.

The threshold level may be based on the concentration or volume of alcohol vapour present in a given volume of air, or the duration of detection of alcohol vapour by the sensor, or a combination thereof. The duration may be a sustained duration at greater than a threshold concentration or volume. Alternatively or additionally, the threshold level may be based on the rate of change of concentration of the sanitising vapour component detected by the sensor. In one example, the threshold may be the rate of change from a positive to a negative rate of change or vice versa.

Advantageously, the signal output from the sensor may be directly or indirectly indicative of the contamination potential.

The sensor may be located at any point on the contamination monitoring device. In a preferred embodiment, the sensor may be located on an outwardly facing section of the contamination monitoring device.

The vapour component detectable by the sensor may derive from any characteristic component of a sanitising composition. Such components may evaporate at room temperature and pressure. The vapour component may form a localised plume detectable by the sensor. Suitable characteristic components of a sanitising composition would be familiar to a person skilled in the art. The vapour component may comprise, for example, an alcohol such as ethanol or propanol, an ether, a perfume or other additive of the sanitising composition, or any combination thereof.

The indicator may be operable to output an indication indicative of the contamination potential. This can provide a readily available indication of the contamination potential associated with the user at any given time.

The indication displayed by the indicator may take the form of a colour, pattern, symbol, or any suitable combination thereof as required or desired. For example, the indicator may comprise one or more illuminable elements, which vary their illumination in response to variation in the signal received from the sensor. The indicator may comprise an LED display, a liquid crystal display, a simple lamp display or similar.

In some embodiments, the indicator may be additionally or alternatively operable to output an audio indication of the contamination potential classification. This audio indication may be output periodically or continuously or in response to the changes in contamination potential associated with the user. The audio indication and/or its mode of operation may be varied according to varying levels of contamination potential. For instance, the audio indication may be provided only when a high contamination potential is determined.

The indicator may be located at any point on the contamination monitoring device. In a preferred embodiment, the indicator is located on an outwardly facing section of the contamination monitoring device that would be visible to other persons present in the environment in which the device is in use.

The contamination monitoring device of the present invention may comprise a processing unit. The processing unit may be integral to the sensor. Alternatively, the processing unit may be integral to the indicator. In a further alternative, the processing unit may be separate from the sensor and the indicator. In particular the processing unit may be provided in a separate package to the device, the separate package being in communication with the device. The communication may be via any suitable wired or wireless link.

The processing unit may be operable to receive a signal from the sensor and to classify the contamination potential based thereon according to any suitable classification scheme. The classification may have a number of levels of contamination potential. In one suitable scheme, the contamination potential may be classified as low, medium/uncertain, or high. In such classification schemes, the classification of the contamination potential may vary from one level to another in response to the detection of varying levels of the vapour component by the sensor. For instance, detection of a threshold level of the vapour component may reduce the contamination potential associated with the user by one or more levels.

The processing unit may comprise a timer means and classification unit. The timer means and the classification unit may be integral to each other or separate. Alternatively, the timer means and/or classification means may be integral either with the sensor or the indicator.

The classification unit may be operable to classify the contamination potential according to a suitable classification scheme as mentioned hereinbefore, and output a signal indicative thereof. The signal output from the classification unit may be received by the indicator.

The timer means may be operable to monitor the time elapsed since a detection of the vapour component by the sensor, and output a signal indicative thereof. The timer means may be operable to monitor the time elapsed since a detection of a certain threshold level of the vapour component by the sensor.

Where the duration of time elapsed since the detection of the vapour component by the sensor is less than a first time threshold, the contamination potential associated with the user may be classified by the classification unit as ‘low’. Where the duration of time elapsed since the detection of the vapour component by the sensor is greater than or equal to a first time threshold but lower than a second time threshold, the contamination potential associated with the user may be classified by the classification unit as ‘medium/uncertain’. Where the duration of time elapsed since the detection of the vapour component by the sensor is greater than or equal to the second time threshold, the contamination potential associated with the user may be classified by the classification unit as ‘high’.

The contamination potential associated with a user may be adjusted from one level of contamination potential to another. For example, once the time elapsed since detection of the vapour component by the sensor is greater than either of the first or second thresholds, the contamination potential associated with the user may adjust from a lower level to a higher level accordingly. If a user subsequently washes their hands using a suitable sanitising composition, the detection of the vapour component by the sensor may be greater than a threshold level such that the classification unit reclassifies the level of contamination potential accordingly. Consequently, the timer means may reset and recommence monitoring the time elapsed since detection of the vapour component by the sensor if a sufficiently low level of contamination potential is achieved. Beneficially, this will allow the user and/or any person present in the environment of use to monitor the contamination potential associated with the user.

The attachment means may comprise any suitable means for holding the device in proximity of the user. The attachment means may be suitable for attachment to an item of clothing worn by the user. The attachment means may comprise, for example, a fastener such as a safety pin, button, clip, clasp or the like. Advantageously, attaching the device to an exterior of an item of clothing worn by the user will enable the indicator to be seen by other persons present in the environment in which the device is used. As such, it will be possible to easily monitor the contamination potential associated with the user.

The contamination monitoring device may take the form of a badge to be affixed to the clothing of the user. The indicator may be operable to change colour to indicate the contamination potential of the user. In a preferred scheme, the colour red would indicate a ‘high’ contamination potential, the colour amber/yellow would indicate a ‘medium/uncertain’ contamination potential and the colour green would indicate a ‘low’ contamination potential associated with the user.

The device may be provided with a reset switch and/or means for receiving a reset signal. This can ensure that the device can be reliably reset to ‘high’ contamination potential when transferred between users.

The device may be powered by any suitable power source. In particular, the power source may be a battery, preferably a rechargeable battery. Additionally or alternatively, the device may include energy scavenging means. The energy scavenging means may be of any suitable type including but not limited to: photoelectric, piezoelectric, thermoelectric and RF scavenging means. The power source and/or the energy scavenging means may be provided in a separate package to the device, the separate package being in communication with the device. The communication may be via any suitable wired or wireless link.

The device of the present invention may be utilised in the monitoring of hygiene in a hospital or other health care environment. The device may be attached to a user on entry to the hospital or health care environment.

According to a third aspect of the present invention, there is provided a sanitising composition suitable for use with a contamination monitoring device according to the first or second aspects of the present invention, the sanitising composition comprising a characteristic vapour component detectable by a sensor.

The characteristic vapour component may be any suitable component capable of evaporating at room temperature and pressure to form a vapour detectable by the sensor. The vapour component may comprise, for example, an alcohol such as ethanol or propanol, an ether, or a perfume. Preferably, the characteristic vapour component comprises a perfume.

The characteristic vapour component may be specific to the sensor. The characteristic vapour component may be an additive to an existing sanitising composition.

The sanitising composition may be in the form of a solid or liquid. Where the composition is a liquid, the liquid may be a highly viscous liquid. The sanitising composition may be in the form of a gel.

The sanitising composition may comprise one or more additional components including, but not limited to, moisturisers, sanitisers, antibacterial and antimicrobial agents, colourings and fragrances.

According to a fourth aspect of the present invention, there is provided a method of monitoring the contamination potential associated with a user, the method comprising the steps of: issuing the user with a device according to the first or second aspects of the present invention; noting an output change in the indicator displaying the level of contamination potential associated with the user.

The third and fourth aspects of the present invention may incorporate any features described in respect of the first and second aspects of the present invention as desired or as appropriate.

In order that the invention is more clearly understood, one embodiment will now be described in more detail, by way of example only, and with reference to the following accompanying drawings, in which:

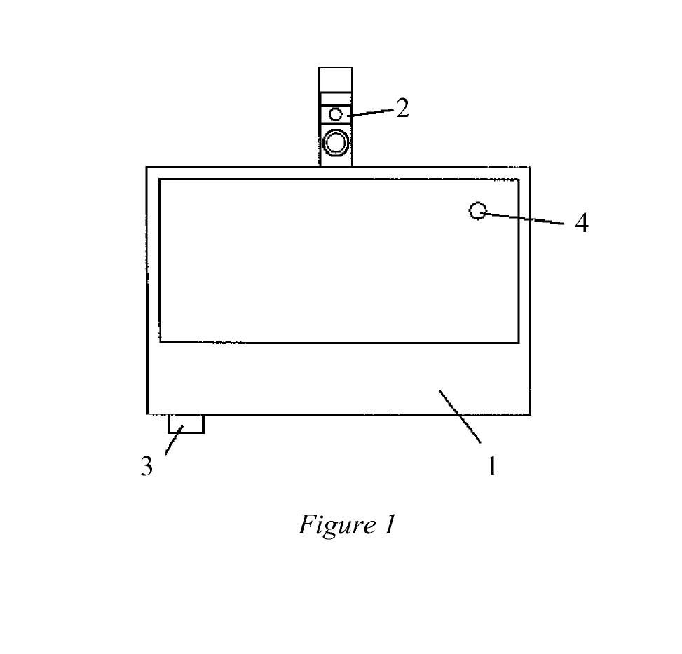

FIG. 1 is a schematic illustration of a contamination monitoring device according to the present invention; and

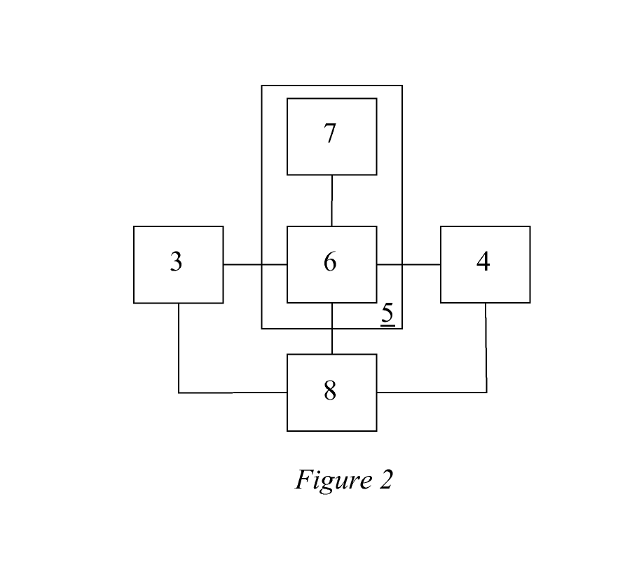

FIG. 2 is a schematic block diagram of the sensing and indication components of the device of FIG. 1.

In the example below, the present invention is described in relation to a user in a hospital or health care environment. It will be appreciated by a person skilled in the art that the invention could equally be utilised in an industrial or commercial environment where contamination is an issue for instance, but not limited to, a chemical processing plant, a semiconductor factory, a commercial kitchen or catering facility, or a prison.

Further, in the example below, the present invention is described in relation a sensor being operable to detect the presence of a vapour component. As mentioned hereinbefore, and as will be appreciated by a person skilled in the art, the sensor could equally comprise, but is not limited to, a temperature sensor, an image/video sensor or an audio sensor; all suitable for detecting the presence of a washing action.

In the example below, the vapour component is described as an alcohol vapour. As mentioned hereinbefore, and as will be appreciated by a person skilled in the art, the vapour component could equally comprise, but is not limited to, ethers, perfumes or other additives present in the sanitising composition. It will of course also be appreciated that the vapour component could equally comprise a characteristic vapour component of a sanitising composition of the present invention.

Referring to FIG. 1, there is shown a contamination monitoring device 1 according to the present invention. The contamination monitoring device 1 comprises an attachment means 2 for holding the device 1 in proximity of a user, a sensor 3 and an indicator 4.

In the present invention, the device 1 can be used to monitor the contamination potential associated with a user. The device 1 is represented in FIG. 1 as a badge, attachable to a user via attachment means 2. It will of course be appreciated that the device 1 may take alternative forms without departing from the scope of the present invention. Such alternative means may be, for example, a button, clip or the like.

On entry into a hospital or health care environment, a user, such as a member of staff, visitor or the like, will be presented with the device 1. The device 1 is attachable to the user using attachment means 2, enabling it to be held in proximity thereto. For maximum effect, the device 1 should be attached in the upper body region of the user.

The attachment means 2 is represented in FIG. 1 as a clasp. The clasp 2 provides a simple and effective means of attaching the device 1 to an item of clothing of a user. It will of course be appreciated that the attachment means 2 is not limited to a clasp. Other suitable means include, but are not limited to, a safety pin, button, clip, clasp or the like.

In order to comply with a hand washing protocol at the hospital or health care environment, the user should wash their hands with a sanitising composition containing an alcohol component as a disinfectant before entering a treatment area. When the user washes their hands, alcohol from the sanitising composition will evaporate in a localised plume. This alcohol vapour will be detected by the sensor 3.

The sensor 3 is operable to detect alcohol vapour evaporated from the alcohol containing sanitising composition. The sensor 3 may comprise a fuel cell (not shown) for detecting the presence of alcohol vapour. It will be appreciated by a person skilled in the art that alternative means of detecting the presence of alcohol vapour may be used in the sensor without departing from the scope of the present invention. Such suitable alternative means may essentially comprise means of detecting a vapour component and means for outputting an electrical signal indicative thereof.

The sensor 3 will output a signal indicative of the alcohol vapour detected to the indicator 4. The signal output by the sensor 3 will vary depending on the concentration or volume, and/or duration, of alcohol vapour detected by the sensor 3. The sensor 3 may only output a signal once a threshold level of alcohol vapour has been detected. Such a threshold level can be set as required or as appropriate for the environment in which the device 1 is in use.

The indicator LED 4 will output an indication in response to the determined contamination potential. The indications will take the form of different colours depending on the contamination potential associated with the user. On initial presentation of the device 1 to the user, the contamination potential associated with the user will be high. This will be displayed on the LED indicator 4, in one embodiment by outputting a red colour. In response to subsequent output of signals by the sensor 3, the contamination potential may vary.

Where the concentration, rate of change of concentration, volume or duration of alcohol vapour detected by the sensor 3 is greater than the threshold level, the sensor 3 may output a signal accordingly. In response, the indicator 4 will output an updated indication according to the contamination potential associated with the user. The indicator 4 may display an amber/yellow colour or a green colour, indicative of a medium/uncertain or a low contamination potential associated with the user respectively.

Once the user has reached the required low contamination potential, they may be allowed to proceed into the area of the hospital or health care environment as desired.

Turning now to FIG. 2, one possible embodiment of the sensing and indication components is illustrated.

In this embodiment, the indicator 4 is in electrical connection with the sensor 3 via a processing unit 5. The processing unit 5 comprises a classification unit 6 and a timer means 7. It is of course possible that the processing unit 5 may be integrated with either the sensor 3 or the indicator 4. The device further comprises an integral power source in the form of a rechargeable battery 8. The battery 8 may be charged by a suitable connection (not shown) to an external power source. Additionally or alternatively, some embodiments may incorporate energy scavenging means for powering the device 1 or recharging the battery 8.

On detection of alcohol vapour, the sensor 3 will output a signal indicative thereof to the classification unit 6. The signal output by the sensor 3 will vary depending on the concentration or volume, and/or duration, of alcohol vapour detected by the sensor 3. The sensor 3 may only output a signal once a threshold level of alcohol vapour has been detected. Such a threshold level can be set as required or as appropriate for the environment in which the device 1 is in use.

The classification unit 6 will receive the signal output from the sensor 3 and classify the level of contamination potential associated with the user.

The contamination potential is classified in three levels, those being low, medium/uncertain, and high. As in the previous embodiment, on initial presentation of the device 1 to the user, the contamination potential associated with the user will be high. To ensure that this is the case, the device may incorporate a reset switch (not shown) or reset signal receiving means (not shown). Additionally or alternatively, the device may be adapted to enter this mode upon power up. This will be displayed on the LED indicator 4. The indicator 4 will initially be displaying a red colour, indicative of a high contamination potential associated with the user.

Where the concentration, rate of change of concentration, volume or duration of alcohol vapour detected by the sensor 3 is greater than a threshold level, the classification unit 6 will reclassify the contamination potential associated with the user accordingly, and output a signal to the indicator 4. The indicator 4 will receive a signal from the classification unit 5 and output an indication according to the contamination potential associated with the user. The indicator 4 may display an amber/yellow colour or a green colour, indicative of a medium/uncertain or a low contamination potential associated with the user respectively.

Once the user has reached the required low contamination potential, they may be allowed to proceed into the area of the hospital or health care environment as desired.

The timer means 7 monitors the duration of time elapsed since the detection of alcohol by the sensor 3. The timer means 7 is in communication with the classification unit 6. The timer means 7 may begin monitoring the duration of time elapsed since the detection of alcohol by the sensor 3 once a low contamination potential has been attained.

Where the duration of time elapsed since the contamination potential has been classified as low is greater than or equal to a first time threshold, the timer means 7 will output this information to the classification unit 6, which will reclassify the level of contamination potential associated with the user accordingly.

The classification unit 6 will then output a signal indicative thereof to the indicator 4. The indicator 4 will receive the signal from the classification unit 6 and output an indication of the new contamination potential, in this case an amber/yellow light to represent a medium/uncertain contamination potential. This will alert the user or member of staff, patient or other person in the vicinity of the user that the contamination potential of the user is uncertain. The user may then decide to re-wash their hands in order to return to a low contamination potential. When a low contamination potential is attained, the timer means 7 will be reset. Alternatively, the user may proceed on the basis that they represent a medium/uncertain contamination potential.

Where the duration of time elapsed since the contamination potential has been classified as low is greater than or equal to a second threshold, the timer means 7 will output this information to the classification unit 6, which will reclassify the level of contamination potential accordingly. The classification unit 6 will output a signal to the indicator 4. The indicator 4 will receive the signal and output an indication of the new contamination potential, in this case a red light to represent a high contamination potential. This will alert the user or a member of staff, patient or other person in the vicinity of the user that the contamination potential associated with the user is high. The user should then re-wash their hands with an alcohol containing sanitising composition in order to return to a low contamination potential. When the contamination potential associated with the user returns to low, the timer means 7 will reset.

It is of course to be understood that the invention is not to be restricted to the details of the above embodiments which are described by way of example only.

1. A contamination monitoring device for monitoring contamination potential associated with a user, the device comprising: attachment means for holding the device in proximity of the user; a sensor being operable to detect the presence of a washing action and output a signal indicative thereof; and an indicator being operable to receive signals output by the sensor and output an indication in response thereto.

2. A contamination monitoring device as claimed in claim 1, wherein the sensor comprises any of the following either alone or in combination: a vapour sensor, a temperature sensor, an image/video sensor and an audio sensor.

3. A contamination monitoring device as claimed in claim 2, wherein the signal is variable in response to the duration of the washing action detected by an image/video or audio sensor; the temperature of water utilised in the washing action detected by a temperature sensor;
or the volume, concentration, rate of change of concentration and/or duration of a vapour component detected by a vapour sensor.

4. A contamination monitoring device for monitoring contamination potential associated with a user, the device comprising; attachment means for holding the device in proximity of the user; a sensor being operable to detect the presence of a vapour component and output a signal indicative thereof; and an indicator being operable to receive signals output by the sensor and output an indication in response thereto.

5. A contamination monitoring device as claimed in claim 1, wherein the signal is an electrical or chemical signal.

6. A contamination monitoring device as claimed in claim 5, wherein there is an electrical pathway between the sensor and the indicator.

7. A contamination monitoring device as claimed in claim 6, wherein the electrical pathway comprises a direct or indirect electrical contact between the sensor and the indicator.

8. A contamination monitoring device as claimed in claim 1, wherein the sensor and the indicator are in communication by means of a wired or wireless link.

9. A contamination monitoring device as claimed in any claim 4, wherein the sensor outputs a signal only after a certain threshold level of the vapour component has been detected.

10. A contamination monitoring device as claimed in claim 4, wherein the threshold level is based on the concentration or volume of alcohol vapour present in a given volume of air, or the duration of detection of alcohol vapour by the sensor, or a combination thereof.

11. A contamination monitoring device as claimed in claim 1, wherein the sensor is located on an outwardly facing section of the contamination monitoring device.

12. A contamination monitoring device as claimed in claim 4, wherein the vapour component detectable by the sensor evaporates at room temperature and pressure.

13. A contamination monitoring device as claimed in claim 12, wherein the vapour component comprises an alcohol, an ether, a perfume or additive of a sanitising composition, or any combination thereof.

14. A contamination monitoring device as claimed in claim 1, wherein the indication displayed by the indicator takes the form of a colour, pattern, symbol, or any combination thereof.

15. A contamination monitoring device as claimed in claim 1, wherein the indicator is operable to output an audio indication.

16. A contamination monitoring device as claimed in claim 1, wherein the indicator is located on an outwardly facing section of the contamination monitoring device.

17. A contamination monitoring device as claimed in claim 1, wherein the device further comprises a processing unit.

18. A contamination monitoring device as claimed in claim 17, wherein the processing unit is provided in a separate package to the device, the separate package being in communication with the device by a wired or wireless link,

19. A contamination monitoring device as claimed in claim 17, wherein the processing unit is operable to receive a signal from the sensor and to classify the contamination potential based thereon according to a classification scheme, the classification scheme comprising a number of levels of contamination potential.

20. A contamination monitoring device as claimed in claim 19, wherein the classification scheme comprises a number of levels of classification, such that the classification of the contamination potential varies from one level to another in response to the detection of varying levels of the vapour component by the sensor.

21. A contamination monitoring device as claimed in claim 17, wherein the processing unit comprises a timer means and classification unit.

22. A contamination monitoring device as claimed in claim 21, wherein the classification unit is operable to classify the contamination potential according to the classification scheme and output a signal indicative thereof.

23. A contamination monitoring device as claimed in claim 21, wherein the timer means is operable to monitor the time elapsed since a detection of the vapour component by the sensor and output a signal indicative thereof.

24. A contamination monitoring device as claimed in claim 20, wherein the contamination potential associated with a user is adjustable from one level of contamination potential to another.

25. A contamination monitoring device as claimed in claim 1, wherein the device takes the form of a badge affixable to the clothing of the user.

26. A contamination monitoring device as claimed in claim 1, wherein the device further comprises a reset switch and/or means for receiving a reset signal.

27. A contamination monitoring device as claimed in claim 1, wherein the device is powered by battery and/or energy scavenging means.

28. A sanitising composition suitable for use with a contamination monitoring device according to claim 1, the sanitising composition comprising a characteristic vapour component detectable by a sensor.

29. A sanitising composition as claimed in claim 28, wherein characteristic vapour component comprises an alcohol, an ether, or a perfume.

30. A sanitising composition as claimed in claim 28, wherein the characteristic vapour component is specific to the sensor.

31. A sanitising composition as claimed in claim 28, wherein the composition is in the form of a solid, liquid or gel.

32. A sanitising composition as claimed in claim 28, wherein the composition further comprises one or more additional components selected from the group consisting of moisturisers, sanitisers, antibacterial and antimicrobial agents, colourings and fragrances.

33. A method of monitoring the contamination potential associated with a user, the method comprising the steps of: issuing the user with a device according to claim 1, noting an output change in the indicator displaying the level of contamination potential associated with the user.

34. (canceled)
